(19) United States
(12) Patent Application Publication
(10) Pub. No.: US 2007/0122152 A1
(43) Pub. Date: May 31, 2007

(54) Method and apparatus for increasing downstream bandwidth of a passive optical network using integrated WDM/power spitting devices and tunable lasers

(76) Inventor: Manyalibo Joseph Matthews, Jersey City, NJ (US)

Correspondence Address: Ryan, Mason & Lewis, LLP, Suite 205, 1300 Post Road, Fairfield, CT, 06824, US

(21) Appl. No.: 11/291,104

(22) Filed: Nov. 30, 2005

(51) Int. Cl. H04J 14/00

(52) U.S. Cl. 398/71

(57) ABSTRACT

Methods and apparatus are disclosed for increasing downstream bandwidth of a passive optical network using integrated WDM/power spitting devices, such as the 2P1 devices, and one or more tunable lasers. An optical multiplexing/demultiplexing system is disclosed that comprises an integrated wavelength division multiplexing (WDM)/power spitting device having a WDM passive optical network (PON) and a power splitting PON; and one or more tunable lasers for selectively generating an optical signal of a desired wavelength for at least one subscriber, wherein the optical signal of a desired wavelength is communicated using the WDM PON. A method is also disclosed for communicating optical signals. One or more signals are broadcast to a plurality of subscribers using a power splitting passive optical network (PON). In addition, one or more private signals for at least one subscriber are generated using one or more tunable lasers; and are communicated to the at least one subscriber using a wavelength division multiplexing (WDM) PON.

### FIELD OF THE INVENTION

The present invention relates generally to optical communication networks, and more particularly, to optical communication networks that include passive components for routing and distributing optical signals.

### BACKGROUND OF INVENTION

Optical fiber networks are increasingly important for the distribution of voice, video, and data signals. Such systems generally involve a number of feeder fibers that emanate from a head-end office, and terminate at respective remote terminals. In a Fiber-To-The-Home or a Fiber-To-The-Curb system, optical signals are transmitted from each of these remote terminals to a number of optical network units over distribution fiber. Signals are transmitted optically or electrically to each optical network unit.

Network architectures have been proposed for transmitting signals between the head-end office and the optical network units. FIG. 1 illustrates a conventional “2-PONs-In-1” (2P 1) device 100 that uses a passive optical branching architecture to exchange signals between a feeder 10 and distribution fibers 20-1 through 20-n. The 2P1 device 100 is said to combine signal broadcasting with signal distribution. The device 100 is referred to as 2-PONs-In-1 because each function is generally handled by a separate passive optical network (PON).

U.S. Pat. No. 5,321,541 to Cohen, incorporated by reference herein, discloses a 2P1 device 100, shown in FIG. 2. The disclosed 2P1 device 100 functions transparently as a dense wavelength division multiplexer (DWDM), for example, at 1550 nanometers (nm) and as a power splitter, for example, at 1310 nm. These two wavelength regions are first separated by a coarse wavelength division multiplexer (WDM) 30. Generally, the 2P1 device 100 overlays a power splitter (PS) PON 50 and a WDM PON 40 on the same optical integrated circuit. The WDM PON 40 can be used to send private signals to each subscriber, while the PS PON 50 can be used simultaneously to broadcast signals. Thus, optical signals in the 1550 nm region are routed around the power splitter 50, which broadcasts optical signals in the 1310 nm region. These parallel signals are then recombined by coarse WDMs 70 at each output port of the 2P1 device.

While these disclosed 2P1 devices effectively allow a WDM PON to send private signals to each subscriber, while the PS PON can be used simultaneously to broadcast signals, no practical solution has been proposed for upgrading a power splitting PON to a WDM PON using the 2P1 devices in a practical and scalable manner. A need therefore exists for methods and apparatus for increasing downstream bandwidth of a passive optical network using integrated WDM/power spitting devices, such as the 2P 1 devices, and tunable lasers. A tunable laser allows individual users to be addressed on the PON such that the system cost scales with cumulative bandwidth demand and not each individual user.

### SUMMARY OF THE INVENTION

Generally, methods and apparatus are disclosed for increasing downstream bandwidth of a passive optical network using integrated WDM/power spitting devices, such as the 2P1 devices, and one or more tunable lasers. According to one aspect of the invention, an optical multiplexing/demultiplexing system is disclosed that comprises an integrated wavelength division multiplexing /power spitting device having a WDM passive optical network and a power splitting PON; and one or more tunable lasers for selectively generating an optical signal of a desired wavelength for at least one subscriber, wherein the optical signal of a desired wavelength is communicated using the WDM PON.

According to another aspect of the invention, a method is disclosed for communicating optical signals. One or more signals are broadcast to a plurality of subscribers using a power splitting passive optical network. In addition, one or more private signals for at least one subscriber are generated using one or more tunable lasers; and are communicated to the at least one subscriber using a WDM PON.

A more complete understanding of the present invention, as well as further features and advantages of the present invention, will be obtained by reference to the following detailed description and drawings.

### BRIEF DESCRIPTION OF THE DRAWINGS FIG. 1 illustrates a conventional 2P1 device;

FIG. 2 illustrates a conventional 2P1 device, as disclosed in U.S. Pat. No. 5,321,541 to Cohen;

FIG. 3 is a schematic block diagram of a conventional power splitter optical multiplexing/demultiplexing system;

FIG. 4 is a schematic block diagram of a conventional wavelength splitting optical multiplexing/demultiplexing system;

FIG. 5 is a schematic block diagram of a conventional power splitting optical multiplexing/demultiplexing system;

FIGS. 6 and 7 illustrate the conventional 2P1 device of FIGS. 1 and 2 in further detail;

FIG. 8 illustrates a wavelength allocation map in accordance with the ITU-T standard;

FIG. 9 illustrates exemplary filter passbands for the 2P 1 devices discussed herein;

FIG. 10 is a schematic block diagram of an optical multiplexing/demultiplexing system incorporating features of the present invention; and

FIG. 11 is a sample table illustrating an exemplary DWDM Grid over a given wavelength range.

### DETAILED DESCRIPTION

The present invention provides methods and apparatus for increasing downstream bandwidth of a passive optical network using integrated WDM/power spitting devices and tunable lasers. Among other benefits, the present invention provides wavelength-on-demand to individual subscribers. According to one aspect of the invention, tunable lasers allow one or more subscribers to be selectively addressed using an associated wavelength or range of wavelengths.

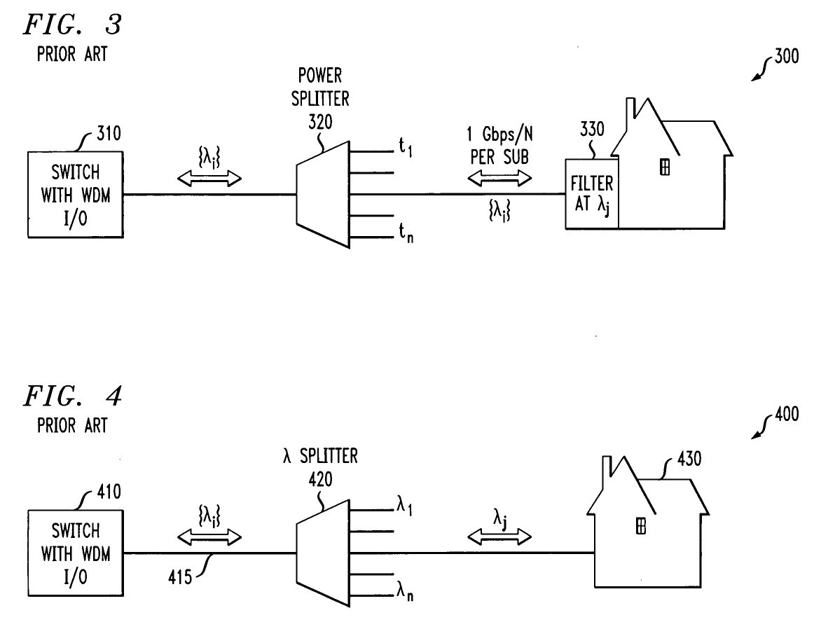

FIG. 3 is a schematic block diagram of a conventional power splitter optical multiplexing/demultiplexing system 300 employing DWDM channels. As shown in FIG. 3, the optical demultiplexing system 300 comprises a switch 310 having a wavelength division multiplexing input/output, such as a laser operating at a wavelength, λᵢ. A power splitter 320 separates the optical signal, λᵢ, into N different copies of the signal, λᵢ, and a filter 330 associated with each subscriber filters the optical signal, λᵢ, to isolate a passband, λⱼ, that is associated with the subscriber. Note that such an upgrade of DWDM signals onto an existing power splitting PON requires adding such a filter during upgrade.

FIG. 4 is a schematic block diagram of a conventional wavelength splitting optical multiplexing/demultiplexing system 400, also referred to as a WDMPON or a wavelength splitter/combiner. Multiple wavelengths, shown in FIG. 4 as λᵢ, are launched each with its own time division multiplexed (TDM) traffic (e.g., 1 Gbps) and combined onto a single fiber at a switch 410. Signals travel over a distribution fiber 415 (SMF, typically up to 20 km) and are then split through a wavelength splitter/router 420. The wavelength splitter 420 separates the optical signal, λᵢ, into N different passbands, λₙ, each associated with a different subscriber, such as the subscriber 430. Likewise, signals originating from the end user 430 and matching the filter passband of his or her port of the wavelength splitter/router 420 can be sent upstream through the system to the OLT. The insertion loss of such a wavelength splitter/router is typically 5-6 dB. A Note that because the wavelength splitter 420 separates the wavelengths, no additional filter is required at the user premises. However, use of the more traditional wavelengths present in commercial PONs (e.g., 1310 and 1490 nm) is difficult because of the DWDM splitter.

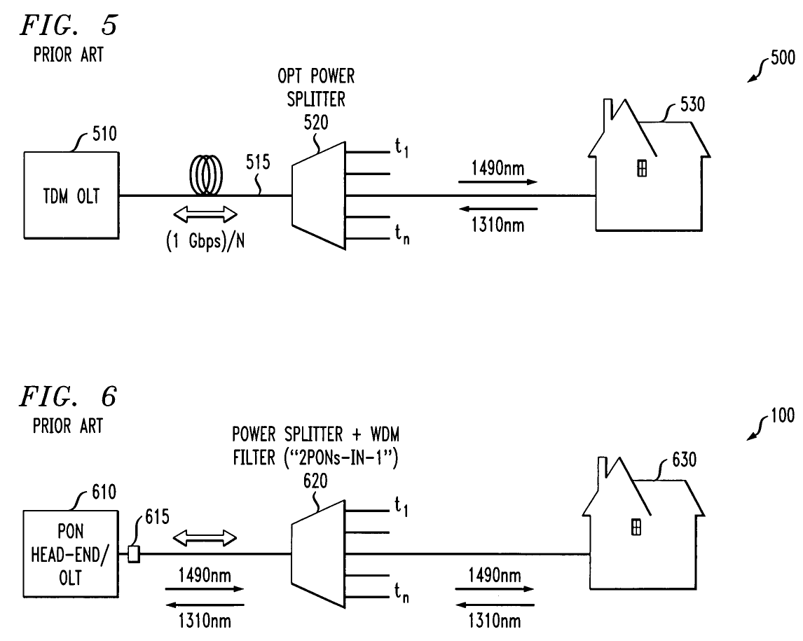

FIG. 5 is a schematic block diagram of a conventional power splitting optical multiplexing/demultiplexing system 500, also referred to as a TDMPON or a power splitter/combiner. As shown in FIG. 5, a single wavelength is launched with the combined/aggregate TDM traffic of all users (e.g., 1 Gbps) into a single fiber 515 at the TDM OLT 510. Signals travel over the distribution fiber 515 (SMF, typically up to 20 km) and are then split through a power splitter/router 520 sending copies of the downstream wavelength to each end user 530. Likewise, signals originating from the end user 530 and time multiplexed with traffic from other end users via Time Division Multiple Access (TDMA) can be sent upstream through the system 500 to the OLT 510. The insertion loss of a power splitter can be 3-20 dB depending on split ratio.

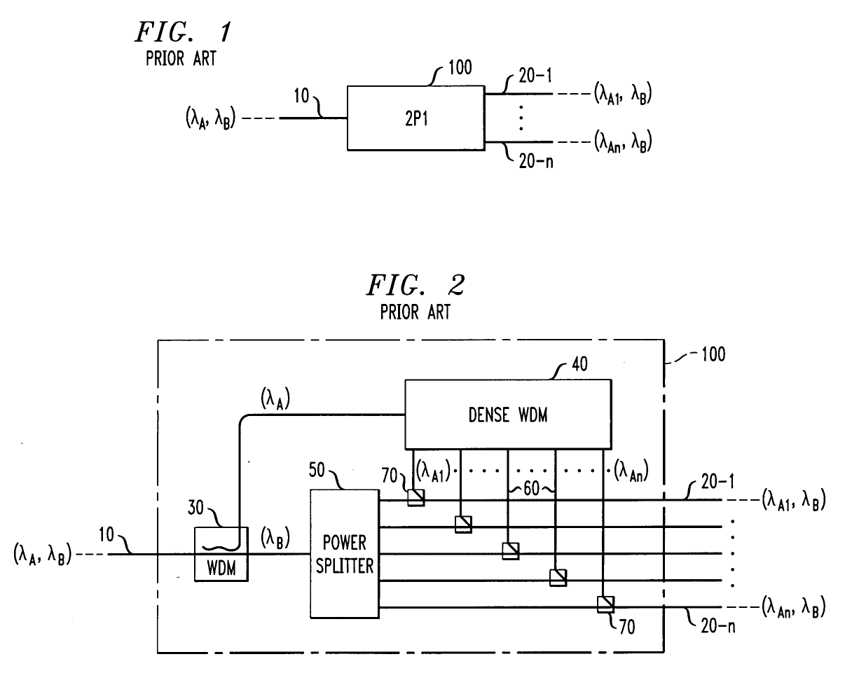

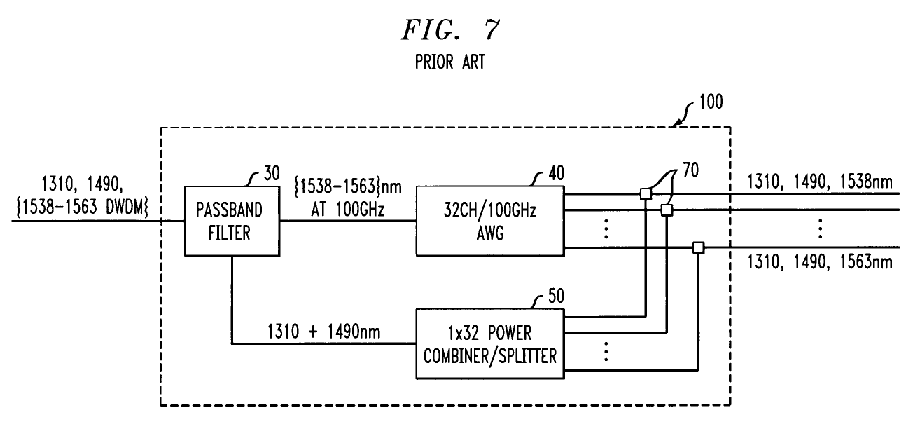

FIGS. 6 and 7 illustrate the conventional 2P1 device 100 of FIGS. 1 and 2 in further detail. As shown in FIG. 6, the exemplary optical demultiplexing system 100 comprises a PON head-end 610 having an associated laser 615 operating at a wavelength of 1490 nm for downstream TDM communications. The head-end 610 also receives upstream TDMA communications of 1310 nm. A 2P1 device 620 separates the optical signal into N different passbands, λₙ, each associated with a different subscriber, such as the subscriber 630.

As shown in FIG. 7, the exemplary 2P1 device 100 functions as a dense wavelength division multiplexer (WDM) around 1550 nanometers, for example, and thus a wavelength range of 1538-1563 nm is applied to the wavelength division multiplexer (WDM) PON 40, such as a 32 channel Array Waveguide Grating. The 2P1 device also functions as a power splitter at 1310 nm and thus wavelengths of 1310 and 1490 nm (upstream and downstream bands, respectively) are applied to the PS PON 50. These two wavelength regions are first separated by a coarse WDM 30, such as a passband filter. The parallel signals are then recombined by coarse WDMs 70 at each output port of the 2P1 device.

The International Telecommunication Union (ITU) has established a number of standards for PONs, including standards G.983.y and G.984.y. These standards support an “enhancement band” in addition to the upstream/downstream digital bands at 1310 and 1490 nm. For example, the G.983.3 standard provides the following options for the “enhancement band”:

| G.983.3 | λ_{lower} (nm) | λᵤₚₚₑᵣ (nm) | Service |
|---|---|---|---|
| Option 1 | 1550 | 1560 | Analog video |
| Option 2 | 1539 | 1565 | DWDM |

Thus, because of the shared and limited bandwidth of the channels at 1310 and 1490 nm, the present invention recognizes that a bi-directional or unidirectional DWDM overlay can dramatically improve services and security over PON systems.

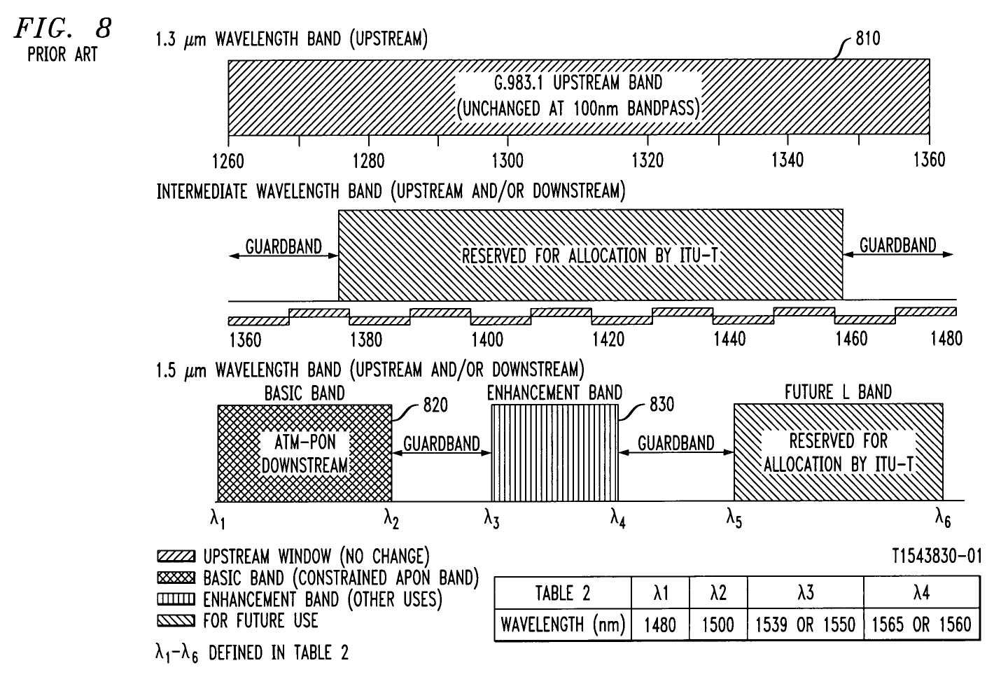

FIG. 8 illustrates a wavelength allocation map in accordance with the ITU-T standard. As shown in FIG. 8, the exemplary upstream band 810 is centered around 1310 nm and the exemplary downstream band 820 is centered around 1490 nm. The present invention recognizes that the enhancement band 830 is available, for example, to provide a WDM function. The potential wavelength ranges for the enhancement band 830 are set forth in Table 2 in FIG. 8.

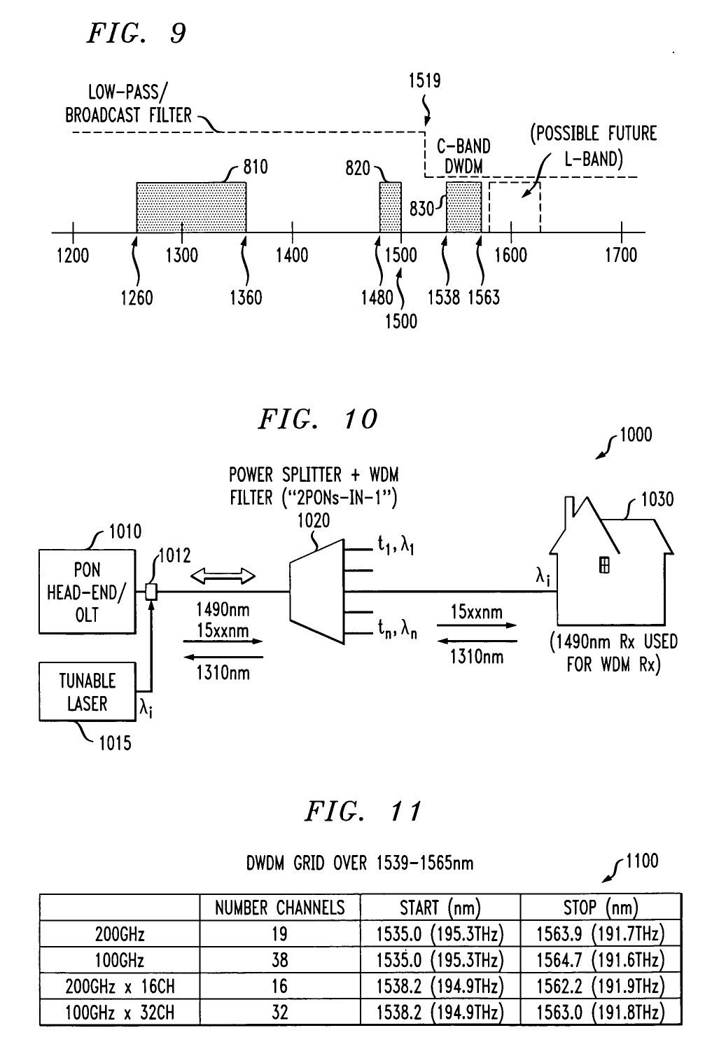

FIG. 9 illustrates exemplary filter passbands for the 2P 1 devices discussed herein. As shown in FIG. 9, the upstream band 810, downstream band 820 and enhancement band 830 of FIG. 8 are set forth. The enhancement band 830 is used for WDM communications, in accordance with the present invention. In addition, the passband filter 30 of the 2P1 device ensures that all subscribers receive (and in principle send) the communications having wavelengths below 1519 nm and the wavelength division multiplexer (WDM) PON 40 can provide given wavelength channels to the appropriate subscribers in the enhancement band 830.

FIG. 10 is a schematic block diagram of an optical multiplexing/demultiplexing system 1000 incorporating features of the present invention. As shown in FIG. 10, the exemplary optical system 1000 comprises a PON head-end 1010 having an associated tunable laser 1015 selectively operating at wavelengths in the enhancement band 830 in the exemplary embodiment for WDM communications. According to one aspect of the invention, the tunable laser 1015 allows one or more subscribers to be selectively addressed using an associated wavelength. The tunable lasers 1015 can be shared over time (TDM) by all subscribers. There is also a filter 1012 that can combine wavelengths from the tunable laser 1015 in the enhancement band with the downstream 1490 nm light. A 2P1 device 1020 separates the optical signal into N different passbands, λₙ, each associated with a different subscriber, such as the subscriber 1030.

During normal operation, the tunable laser 1015 is off and all end users receive TDM broadcast traffic from the service provider head-end 1010, while transmitting 1310 nm light upstream using TDMA and scheduling to avoid collisions. When a subscriber requests bandwidth, the tunable laser 1015 (in accordance with a look-up table) transmits at the wavelength associated with the subscriber using the WDM/PS splitter.

It is noted that, because the subscriber cannot filter the combined enhancement wavelengths and 1490 nm downstream traffic, complete noise would result in a typical WDM/PON overlay system. Due to the nature of the WDM/PS filter, however, which necessarily has unequal insertion losses for the WDM signals versus the PS signals, the DWDM signal will always be approximately 10 dB stronger than the PS signal, thereby overpowering the 1490 nm downstream light (without the need for a filter at each subscriber). Furthermore, the large dynamic range of the subscriber receivers is advantageous, which are designed to specifically for cascaded splitter PONs which have widely varying path losses (up to 20 dB).

In general, the difference in insertion loss can be obtained as follows:
lossdiff=10 log N+α_{PS} L_{eff,PS} −α_{WDM} L_{eff,WDM}
where N is the number of splits, α_{PS} is the additional path loss per length of power splitter, L_{eff,PS} is the effective length of the power splitter, α_{WDM} is the additional path loss per length of WDM splitter, and L_{eff,WDM} is the effective length of the WDM splitter.

Once the user demand has been fulfilled, the tunable laser 1015 can then serve another subscriber in accordance with his or her demand. It is noted that any subscriber can have up to the full TDM channel capacity without reducing (and, in fact, increasing) the traffic load offered to other users. Even with an additional tunable laser 1015, each tunable laser 1015 signal would be approximately 7 dB larger than the power splitting traffic. Of notable economic and scaling interest, the tunable laser 1015 does not need to be inserted into a given system until the service provider sees a need for an upgrade, thereby saving deployment costs.

Among other benefits, the present invention allows power splitting PONs to be upgraded to include WDM PON solutions (without changes to customer premises equipment). In this manner, the disclosed passive optical networks can provide wavelength-on-demand to individual subscribers. It is noted that the data rate of the WDM is equal to or less than that of PS, thus allowing the use of the same (wideband) optical receiver. Furthermore, the tunable lasers 1015 allow the temperature drift normally associated with WDM passband at the power splitter to be countered by actively adjusting the wavelength. In addition, the tunable lasers 1015 can be shared over time by all subscribers.

FIG. 11 is a sample table 1100 illustrating an exemplary DWDM Grid over 1539-1565 nm. As shown in FIG. 11, the table 1100 identifies, for a number of different channel spacings, the number of potential channels, as well as the starting and stopping wavelengths.

It is to be understood that the embodiments and variations shown and described herein are merely illustrative of the principles of this invention and that various modifications may be implemented by those skilled in the art without departing from the scope and spirit of the invention. For example, multiple tunable lasers and cascaded splitters can be employed in the disclosed optical multiplexing/demultiplexing systems, as would be apparent to a person of ordinary skill in the art.

I claim:

1. An optical multiplexing/demultiplexing system, comprising:
an integrated wavelength division multiplexing (WDM)/power spitting device having a WDM passive optical network (PON) and a power splitting PON; and
one or more tunable lasers for selectively generating an optical signal of a desired wavelength, wherein said optical signal of a desired wavelength is communicated using said WDM PON.

2. The optical system of claim 1, further comprising one or more filters to combine wavelengths from said one or more tunable lasers with downstream light.

3. The optical system of claim 1, wherein said integrated WDM/power spitting device includes a WDM PON to send private signals to one or more subscribers.

4. The optical system of claim 1, wherein said integrated WDM/power spitting device includes a WDM PON to receive private signals from one or more subscribers.

5. The optical system of claim 1, wherein said integrated WDM/power spitting device includes a power splitting PON to broadcast signals to a plurality of subscribers.

6. The optical system of claim 1, wherein said integrated WDM/power spitting device is a 2-PONs-In-1 device.

7. The optical system of claim 1, wherein said integrated WDM/power spitting device employs power splitting techniques to provide upstream and downstream communications with one or more subscribers.

8. The optical system of claim 1, wherein said one or more tunable lasers allow a temperature drift to be reduced by actively adjusting said desired wavelength.

9. The optical system of claim 1, wherein said one or more tunable lasers has a data rate up to the data rate of power splitting passive optical network.

10. A method for communicating optical signals, comprising:
broadcasting one or more signals to a plurality of subscribers using a power splitting passive optical network (PON);
generating one or more private signals for at least one subscriber using one or more tunable lasers; and
communicating said one or more private signals to said at least one subscriber using a wavelength division multiplexing (WDM) PON.

11. The method of claim 10, further comprising the step of combining said private signals from said one or more tunable lasers with wavelengths associated with said broadcast signal.

12. The method of claim 10, wherein said power splitting passive optical network and said WDM PON comprise an integrated WDM/power spitting device.

13. The method of claim 10, wherein said integrated WDM/power spitting device is a 2-PONs-In-1 device.

14. The method of claim 10, further comprising the step of using said one or more tunable lasers to actively adjust one or more wavelengths.

15. The method of claim 10, further comprising the step of receiving one or more private signals from one or more subscribers using said WDM PON.

16. The method of claim 10, wherein said private signals have a data rate up to the data rate of the power splitting passive optical network.

17. An optical device, comprising:
a power splitting passive optical network (PON) for broadcasting one or more signals to a plurality of subscribers;
one or more tunable lasers for generating one or more private signals for at least one subscriber; and
a wavelength division multiplexing (WDM) PON for communicating said one or more private signals to said at least one subscriber.

18. The optical device of claim 17, wherein said WDM PON receives private signals from one or more subscribers.

19. The optical device of claim 17, wherein said one or more tunable lasers allow a temperature drift to be reduced by actively adjusting a desired wavelength.

20. The optical device of claim 17, wherein said one or more tunable lasers has a data rate up to the data rate of said power splitting passive optical network.
